(19) United States
(12) Patent Application Publication
(10) Pub. No.: US 2014/0122794 A1
(43) Pub. Date: May 1, 2014

(54) CONTROL CIRCUIT FOR HARD DISKS

(71) Applicants: HON HAI PRECISION INDUSTRY CO., LTD., New Taipei (TW); HONG FU JIN PRECISION INDUSTRY (SHENZHEN) CO., LTD, Shenzhen (CN)

(72) Inventors: JIA LI, Shenzhen (CN); JUN-JIA LIN, Shenzhen (CN)

(73) Assignees: HON HAI PRECISION INDUSTRY CO., LTD., New Taipei (TW); HONG FU JIN PRECISION INDUSTRY (SHENZHEN) CO., LTD, Shenzhen (CN)

(21) Appl. No.: 14/067,884

(22) Filed: Oct. 30, 2013

(30) Foreign Application Priority Data
Oct. 30, 2012 (CN) 2012104231699

(51) Int. Cl. G06F 3/06

(52) U.S. Cl. CPC G06F 3/0604; G06F 3/0655; G06F 3/0689
USPC 711/112

(57) ABSTRACT

A control circuit is connected between a motherboard and a number of hard disks for controlling power and data transmission of the number of hard disks. Each hard disk corresponds to one power control unit and one data control unit. The power control unit controls power transmission to the corresponding hard disk. The data control unit controls data transmission of the corresponding hard disk. When one hard disk is selected as an operation object to enter a disable state, the data control unit cuts off data transmission of the selected hard disk before the power control unit cuts off power transmission of the operation object. When the hard disk is selected as an operation object to enter an enable state, the power control unit resets the power transmission to the operation object before the data control unit resets data transmission of the operation object.

### BACKGROUND

1. Technical Field

The present disclosure relates to a control circuit for hard disks used in a server.

2. Description of Related Art

Using a plurality of hard disks in a server for providing a large amount of storage space is well known. However, when one of the hard disks malfunctions (e.g., is damaged or infected by viruses), the server needs to be turned off to replace or maintain the malfunctioned hard disk, which is inconvenient and causes interruption of other services of the server.

Therefore, what is needed is a means to overcome the above described shortcoming.

### BRIEF DESCRIPTION OF THE DRAWINGS

The components in the drawings are not necessarily drawn to scale, the emphasis instead being placed upon clearly illustrating the principles of at least one embodiment. In the drawings, like reference numerals designate corresponding parts throughout the various views.

FIG. 1 is a block diagram of a control circuit for controlling hard disks according to a first exemplary embodiment of the present disclosure.

FIGS. 2 and 3 are schematic diagrams of the control circuit of FIG. 1.

FIG. 4 shows a sequence waveform of input/output pins of the control circuit of FIG. 2.

FIG. 5 is a schematic diagram of a control circuit for controlling hard disks according to a second exemplary embodiment of the present disclosure.

### DETAILED DESCRIPTION

Reference will be made to the drawings to describe various embodiments in detail.

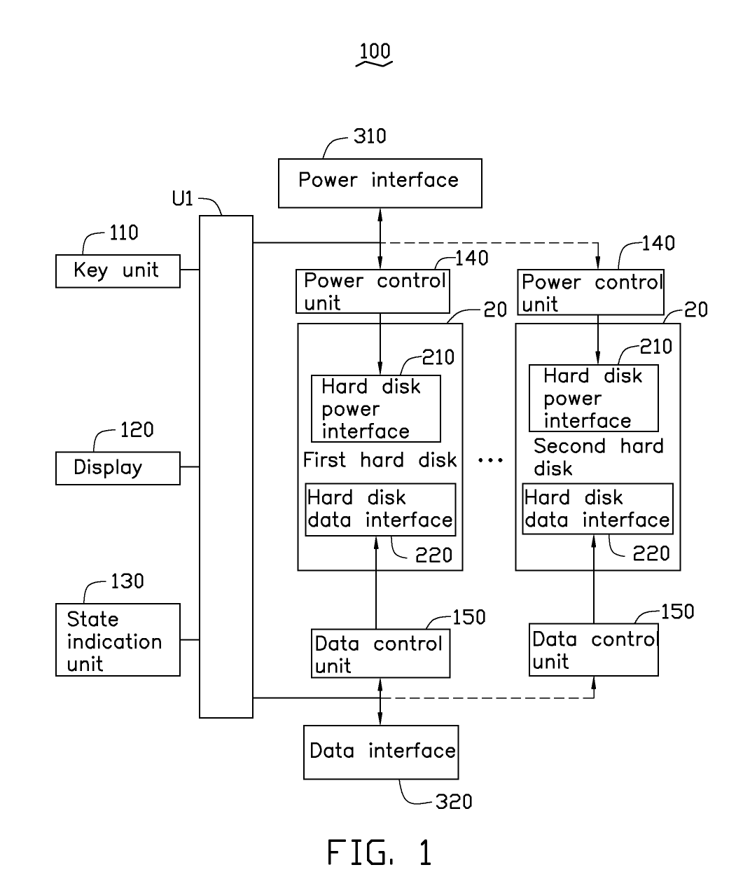

FIG. 1 is a block diagram of a control circuit 100 for controlling hard disks according to a first exemplary embodiment of the present disclosure. The control circuit 100 is arranged on a motherboard of a server for power control and data transmission of a plurality of hard disks 20. The hard disks 20 are sequentially labeled as first hard disk, second hard disk, . . . Nth hard disk (N is a natural number). Each hard disk 20 includes a hard disk power interface 210 and a hard disk data interface 220. Power is supplied to the hard disks 20 through a power interface 310. A data interface 320 configured to read and write data of the hard disks 20 is connected to the plurality of hard disks 20.

The control circuit 100 includes a controller U1, a key unit 110, a display 120, a state indication unit 130, a plurality of power control units 140, and a plurality of data control units 150. Each hard disk 20 corresponds to one of the power control units 140 and one of the data control units 150. The power control unit 140 is connected between the motherboard power interface 310 and the hard disk power interface 210. The data control unit 150 is electrically connected between the data interface 320 and the hard disk data interface 220. The key unit 110 includes a plurality of input keys. The key unit 110 is configured to select one of the hard disks 20 as an operation object and control the power and data transmission of the selected hard disk 20. The controller U1 controls the operation object to enter an enable state or a disable state. The enable state enables ability of the hard disk 20 to save data, and the disable state disables ability of the hard disk 20 to save data. The display 120 displays a label of the selected hard disk 20. The state indication unit 130 indicates a working state of the operation object, such as the enable state, a selection state, or the disable state, a normal working state, a selection state, or an operation state. The power control unit 140 controls power transmission to a corresponding hard disk 20, and the data control unit 150 controls data transmission of a corresponding hard disk 20.

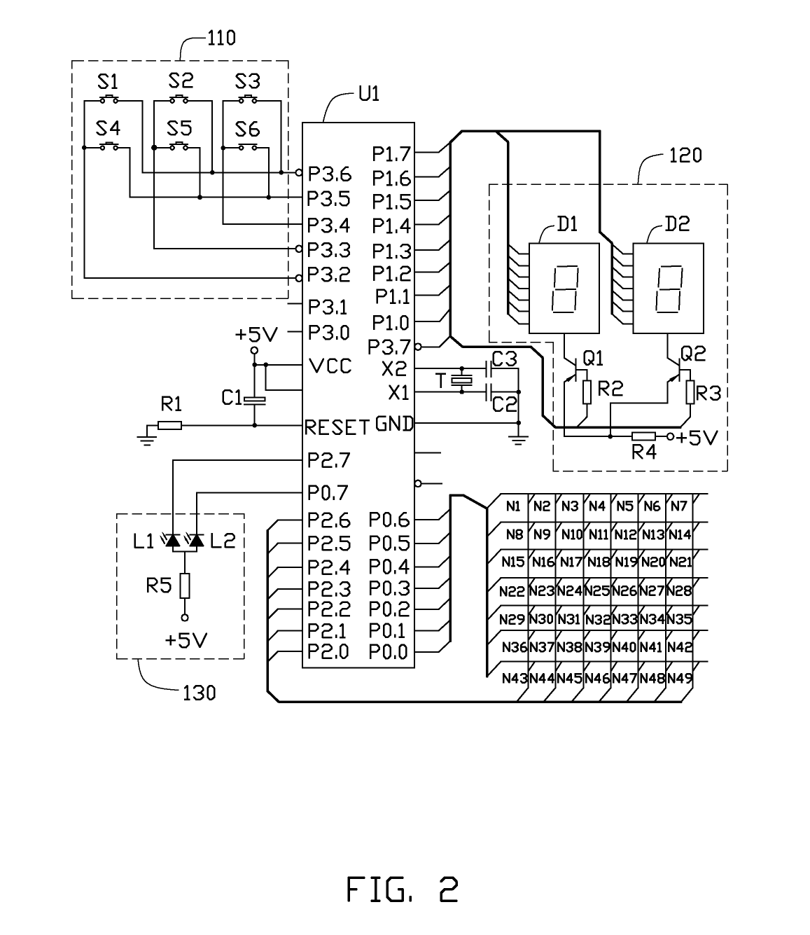

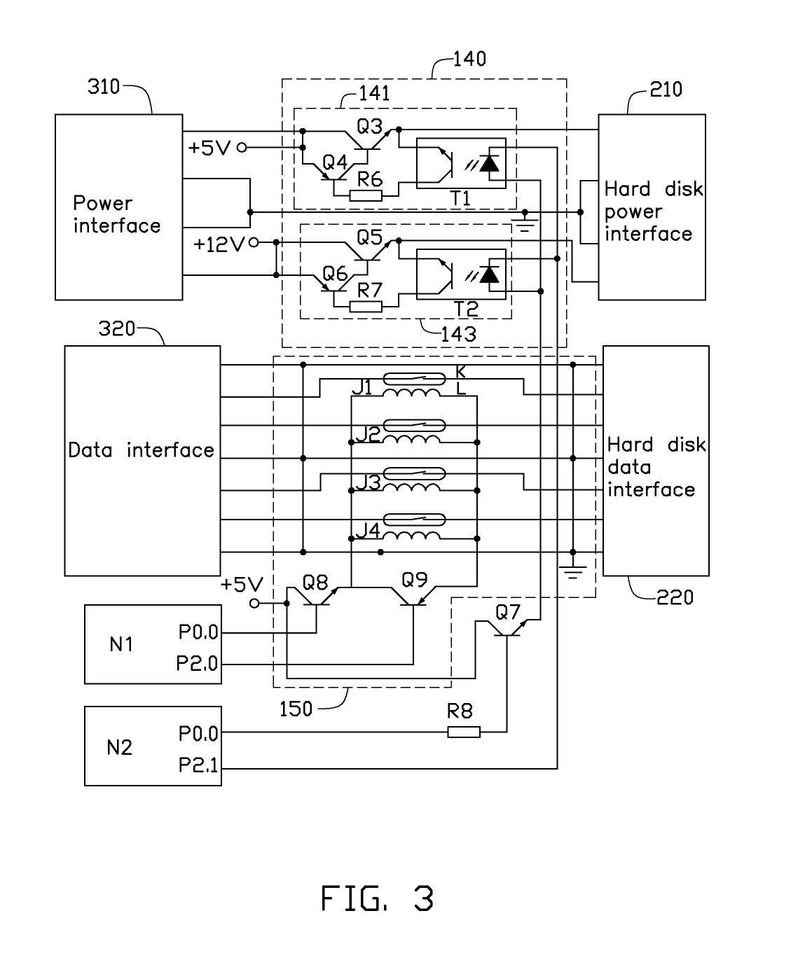

FIGS. 2 and 3 show a schematic circuit diagram of the control circuit 100. The controller U1 includes a number of input/output (I/O) pins, which are enabled by a logic-high signal, and a number of I/O pins, which are enabled by a logic-low signal. In the embodiment, the controller U1 includes a power pin VCC, a ground pin GND, a reset pin RESET, two clock pins X1, X2, and a plurality of I/O pins P0.0-P0.7, P1.0-P1.7, P2.0-P2.7, and P3.0-P3.7. The power pin VCC is electrically connected to a first power source (e.g. +5V), and the ground pin GND is grounded. The I/O pins P0.0-P0.7 are enabled by a logic high signal (e.g., digital signal “1”). The I/O pins P2.0-P2.7 are enabled by a logic low signal (e.g., digital signal “0”). The reset pin RESET is grounded via a first resistor R1. The reset pin RESET is also electrically connected to the first power source via a first capacitor C1. The first resistor R1 and the first capacitor C1 form a reset circuit of the controller U1. A quartz crystal T is electrically connected between the two clock pins X1 and X2. The clock pin X1 is grounded via a second capacitor C2. The clock pin X2 is grounded via a third capacitor C3. The quartz crystal T, the second capacitor C2, and the third capacitor C3 form a clock circuit of the controller U1 to generate clock signals and send the clock signals to the controller U1.

The I/O pins P0.0-P0.6, P2.0-P2.6 form a matrix control circuit having 49 terminals. In detail, the I/O pins P0.0 and P2.0 form a first control terminal group N1, the I/O pins P0.0 and P2.1 form a second control terminal group N2, the I/O pins P0.0 and P2.2 form a third control terminal group N3, the I/O pins P0.0 and P2.3 form a fourth control terminal group N4, and so on. The I/O pins P0.5 and P2.0 form an eighth control terminal group N8, and the I/O pins P0.4 and P2.0 form a fifteenth control terminal group N15, and so on. The other terminals are formed in a similar sequential manner. The data control unit 150 is electrically connected between the I/O pins P0.0 and P2.0 via the first control terminal group N1. The power control unit 140 is electrically connected between the I/O pins P0.0 and P2.1 via the second control terminal group N2.

The I/O pins P1.1-P1.7 are electrically connected to the display 120. The display 120 includes a first digital tube D1 and a second digital tube D2. The first digital tube D1 and the second digital tube D2 each include seven I/O pins (not labeled). The I/O pins of both the first digital tube D1 and the second digital tube D2 are electrically connected to the I/O pins P1.1-P1.7, one-to-one. The display 120 further includes a first transistor Q1 and a second transistor Q2. The first transistor Q1 and the second transistor Q2 amplify a driving current of the first and second digital tubes D1 and D2, respectively. A base of the first transistor Q1 is electrically connected to the I/O pins P1.0 and P3.7 via a second resistor R2. A base of the second transistor Q2 is electrically connected to the I/O pins P1.0 and P3.7 via a third resistor R3. An emitter of the first transistor Q1 and an emitter of the second transistor Q2 are electrically connected to the first power source via a fourth resistor R4. A collector of the first transistor Q1 is electrically connected to the first digital tube D1, and a collector of the second transistor Q2 is electrically connected to the second digital tube D2. In the embodiment, the first digital tube and the second digital tube are seven-segment displays.

In the embodiment, the first and second transistors Q1 and Q2 are pnp-type bipolar junction transistors (pnp-BJT).

The key unit 110 includes six keys S1-S6. The key S1 is electrically connected between the I/O pins P3.2 and P3.6. The key S2 is electrically connected between the I/O pins P3.3 and P3.6. The key S3 is electrically connected between the I/O pins P3.4 and P3.6. The key S4 is electrically connected between the I/O pins P3.2 and P3.5. The key S5 is electrically connected between the I/O pins P3.3 and P3.5. The key S6 is electrically connected between the I/O pins P3.4 and P3.5.

The key S1 is a function key for manually selecting one of the hard disks 20 as the operation object. The key S2 is a function key for selecting a next hard disk 20. The key S3 is a function key for selecting a previous hard disk 20. The key S4 is a confirmation key. The key S5 is a function key for controlling the hard disk 20 to enter the enable state. The key S6 is a function key for controlling the hard disk 20 to enter the disable state. Once the hard disk 20 is in the disable state, a user can eject the hard disk 20. After the hard disk 20 is inserted, the hard disk 20 enters the enable state.

The state indication unit 130 includes a first LED L1, a second LED L2, and a fifth resistor R5. One end of the fifth resistor R5 is electrically connected to the first power source, and the other end of the fifth resistor R5 is electrically connected to the I/O pins P0.7 and P2.7 via the first LED L1 and the second LED L2. In the embodiment, the first LED L1 emits green light, and the second LED L2 emits red light.

The power control unit 140 includes a first control circuit 141 to control power transmission from the first power source to one hard disk 20, and a second control circuit 143 to control power transmission from a second power source (e.g. +12V) to one hard disk 20. The first control circuit 141 includes a third transistor Q3, a fourth transistor Q4, a sixth resistor R6, and a first optocoupler T1. The first power source is electrically connected to the hard disk power interface 210 of the first hard disk 20 via a collector and an emitter of the third transistor Q3. The first power source is further electrically connected to an emitter of the fourth transistor Q4. A base of the fourth transistor Q4 is electrically connected to the hard disk power interface 210 via the sixth resistor R6 and the first optocoupler T1. The optocoupler T1 includes a diode (not labeled). An anode of the diode of the first optocoupler T1 is electrically connected to the input and output pin P0.0 of the second control terminal group N2 via a seventh transistor Q7 and an eighth resistor R8. A cathode of the diode of the first optocoupler T1 is electrically connected to the input and output pin P2.1 of the second control terminal group N2.

The second control circuit 143 includes a fifth transistor Q5, a sixth transistor Q6, a seventh resistor R7, and a second optocoupler T2. The second power source is electrically connected to the hard disk power interface 210 via a collector and an emitter of the fifth transistor Q5. The second power source is further electrically connected to an emitter of the sixth transistor Q6. A collector of the sixth transistor Q6 is electrically connected to a base of the fifth transistor Q5. A base of the sixth electrode Q6 is electrically connected to the hard disk power interface 20 via the seventh resistor R7 and the second optocoupler T2. The second optocoupler T2 includes a diode (not labeled). An anode of the diode of the second optocoupler T2 is electrically connected to the I/O pin P0.0 of the second control terminal group N2. A cathode of the diode of the second optocoupler T2 is electrically connected to the I/O pin P2.1. A collector of the seventh transistor Q7 is electrically connected to the first power source.

In the embodiment, the third transistor Q3, the fifth transistor Q5, and the seventh transistor Q7 are npn-type bipolar junction transistors (npn-BJT). The fourth transistor Q4 and the sixth transistor Q6 are pnp-BJTs.

In the embodiment, the hard disk data interface 220 is a serial advanced technology attachment (SATA) interface. The SATA interface includes seven conductive wires, in which three conductive wires are ground wires to prevent electromagnetic interference (EMI), and the other four wires are data wires. The data control unit 150 includes four dry-reed relays J1-J4 corresponding to the four data wires of the SATA interface. Each dry-reed relay includes a switch K and an inductor L. In the embodiment, the switch K is normally closed. When the inductor L is powered on, the switch K is turned on.

One end of each inductor L is electrically connected to an emitter of an eighth transistor Q8, and another end of each inductor L is electrically connected to an emitter of a ninth transistor Q9. A base of the eighth transistor Q8 is electrically connected to the I/O pin P0.0 of the first control terminal group N1. A base of the ninth transistor Q9 is electrically connected to the I/O pin P2.0 of the first control terminal group N1. A collector of the eighth transistor Q8 is electrically connected to the first power source. A collector of the ninth transistor Q9 is grounded.

In the embodiment, the eighth transistor Q8 is an npn-BJT, and the ninth transistor Q9 is a pnp-BJT.

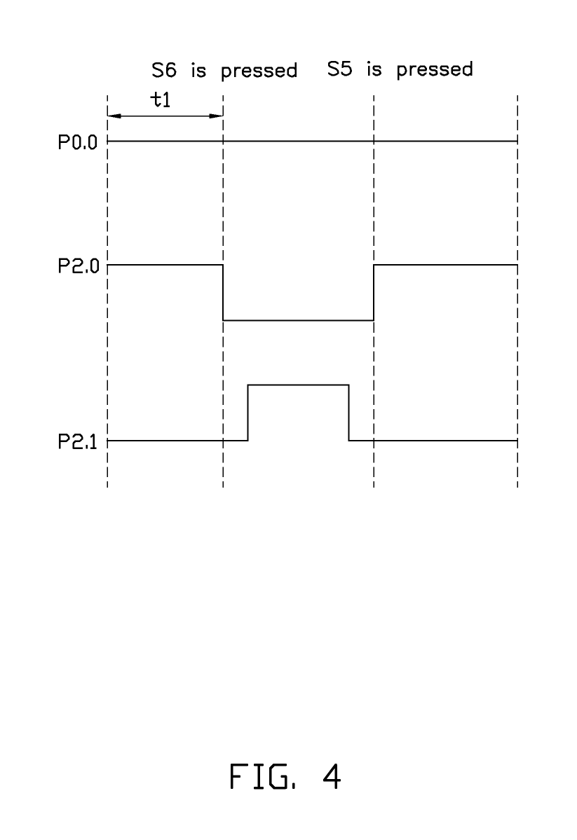

FIG. 4 shows a sequence waveform of the I/O pins P0.0, P2.0, and P2.1. In the embodiment, each hard disk 20 is controlled in a similar manner, so the first hard disk 20 is described as an example. During a first period t1, the first hard disk 20 works normally, so the I/O pins P0.0 and P2.0 output a logic high signal, and the I/O pin P2.1 outputs a logic low signal. The logic high signal of the I/O pin P0.0 is transmitted through the base and the emitter of the seventh transistor Q7 and the diode of the first optocoupler T1 to the I/O pin P2.1. Then, the optocoupler T1, the third transistor Q3, and the fourth transistor Q4 are turned on, and the first power source supplies power to the first hard disk 20. The second power source supplies power to the first hard disk 20 in the same manner. Since the I/O pins P0.0 and P2.0 output the logic high signal, each inductor L is not powered on, and the switch K of the dry-reed relays J1-J4 is kept in a closed state. Therefore, the hard disk data interface 220 of the first hard disk 20 works normally, and the first LED L1 is turned on to indicate that the first hard disk 20 is in the enable state.

When one hard disk malfunctions, the key S1 can be pressed to start a selection process for selecting the malfunctioned hard disk as the operation object.

During the selection process, the key S2 or the key S3 is pressed to select the hard disk 20. In the embodiment, the first hard disk 20 is the operation object. Then, both the first LED L1 and the second LED L2 are turned on to indicate which hard disk 20 is selected. The display 120 displays a label of the selected hard disk 20 using the first and second digital tubes D1 and D2. When the key S6 is pressed, the I/O pin P2.0 outputs the logic low signal (e.g. logic 0), and the logic high signal of the I/O pin P0.0 is transmitted to the I/O pin P2.0 through the eighth transistor Q8, the inductor L of the dry-reed relays J1-J4, and the I/O pin P2.0. The switches K of the dry-reed relays J1-J4 are switched off to cut off data transmission of the four data wires. Then, the I/O pin P2.1 outputs the logic high signal to turn off the first and second optocouplers T1 and T2, the third transistor Q3, the fourth transistor Q4, the fifth transistor Q5, and the sixth transistor Q6, to cut off power transmission to the operation object. Finally, the first hard disk 20 is in the disable state.

When the key S5 is pressed, the control circuit 100 first restores the power transmission of the first hard disk 20, and then restores the data transmission of the first hard disk 20. The second LED L2 is turned on simultaneously to indicate that the first hard disk 20 is returned to the normal operation state.

When the key S6 is pressed, the first LED L1 is turned on again to indicate that the first hard disk 20 is in the enable state.

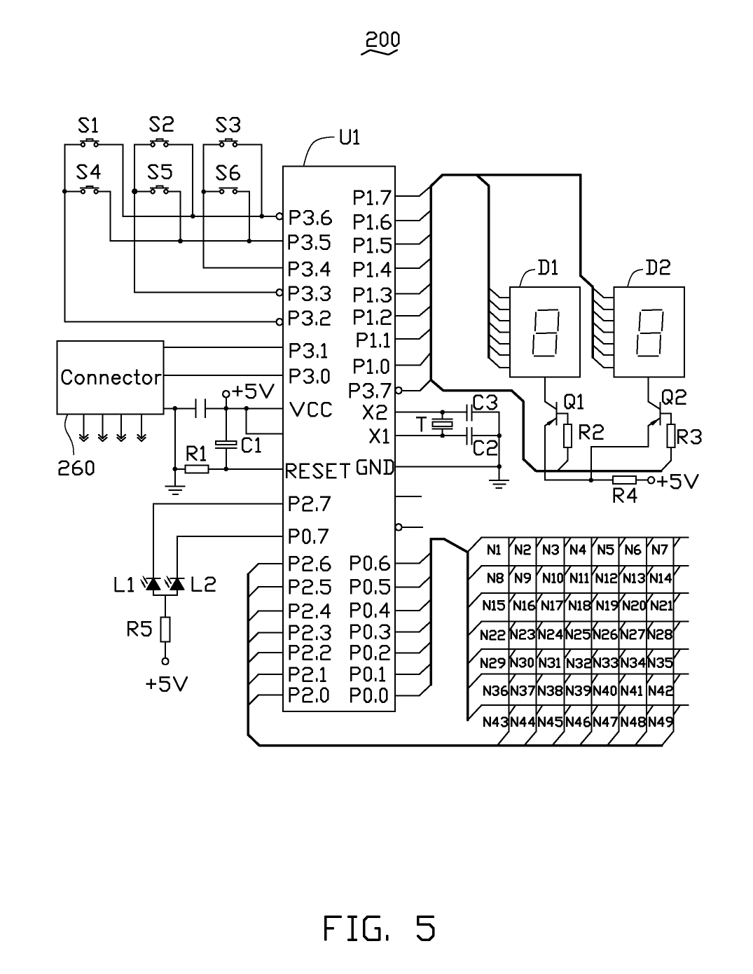

FIG. 5 shows a control circuit 200 for controlling hard disks according to a second embodiment. The control circuit 200 is similar to the control circuit 100, except that the control circuit 200 further includes a connector 260 electrically connected to the I/O pins P3.0 and P3.1. The connector 260 is further electrically connected to a host. Thus, the hard disks 20 can be turned on or off by the host.

In summary, when one hard disk is damaged or infected by viruses, the damaged or infected hard disk can be selected as an operation object via the control circuit, and the control circuit controls power and data transmission of the operation object. Thus, the damaged or infected hard disk can be replaced during operation of the server. Therefore, maintenance of the server is improved.

It is to be understood that even though numerous characteristics and advantages of the present embodiments have been set forth in the foregoing description, with details of the structures and functions of the embodiments, the disclosure is illustrative only, and that changes may be in detail, especially in the matters of arrangement of parts within the principles of the embodiments to the full extent indicated by the broad general meaning of the terms in which the appended claims are expressed.

What is claimed is:

1. A control circuit for controlling power and data transmission of a plurality of hard disks, comprising:
a key unit selecting one of the hard disk as an operation object,
a plurality of power control units, each power control unit controlling power transmission of a corresponding hard disk,
a plurality of data control units, each data control unit controlling data transmission of corresponding one hard disk,
a controller electrically controlling the operation object to enter an enable state or a disable state;
wherein when the objection object enters the disable state, the controller controls the data control unit cut off data transmission of the operation object before the power control unit cuts off power transmission of the operation object, when the operation objection enters the enable state, the controller controls the power control unit recover the power transmission of the operation object before the data control unit recovers data transmission of the operation object.

2. The control circuit of claim 1, wherein the plurality of hard disks are sequentially numbered, the control circuit further comprises a display to display a label of the selected hard disk.

3. The control circuit of claim 2, wherein further comprising a state indication unit to indicate a working state of the operation object, the working state comprises the enable state, a selection state, and the disable state.

4. The control circuit of claim 3, wherein the controller comprises a power pin, a ground pin, a reset pin, and two clock pins, the power pin is electrically connected to a first power source, the ground pin is grounded, the reset pin is grounded via a first resistor and electrically connected to the first power source via a first capacitor, the first resistor and the first capacitor form a reset circuit of the controller, a quartz crystal is electrically connected between the two clock pins, one clock pin is grounded via a second capacitor, the other clock pin is grounded via a third capacitor, the quartz crystal, the second capacitor, and the third capacitor form a clock circuit of the controller to generate clock signals to the controller.

5. The control circuit of claim 3, wherein the controller further comprises a plurality of input and output pins (I/O) to form a matrix control circuit having a plurality of control terminal groups, two adjacent control terminal groups form a control interface for one hard disk, one control terminal group of the two adjacent control terminal groups is electrically connected to the power control unit, and the other control terminal group of the two adjacent control terminal groups is electrically connected to the data control unit.

6. The control circuit of claim 3, wherein the controller further comprises N I/O pins enabled by a logic high signal, and M I/O pins enabled by a logic low signal to form a matrix control circuit having N*M control terminal groups, two adjacent control terminal groups form a control interface for one hard disk, one control terminal group of the two adjacent control terminal groups is electrically connected to the power control unit, and the other control terminal group of the two adjacent control terminal groups is electrically connected to the data control unit.

7. The control circuit of claim 6, wherein the display comprises a first digital tube, a second digital tube, a first transistor, and a second transistor, the first transistor and the second transistor amplify a driving current of the first and second digital tubes.

8. The control circuit of claim 7, wherein the key unit comprises six keys, a first key is a function key for manually selecting one of the hard disks as the objection, a second key is a function key for selecting a next hard disk, a third key is a function key for selecting an up hard disk, a fourth key is a confirmation key, a fifth key is a function key for inserting the hard disk, and a sixth key is a function key for ejecting the hard disk.

9. The control circuit of claim 8, wherein the first power source and a second power source supply power for the hard disk cooperatively, and each power control unit comprises a first control circuit to control power transmission from the first power source to one hard disk and a second control circuit to control power transmission from the second power source to one hard disk.

10. The control circuit of claim 9, wherein the first control circuit comprises a third transistor, a fourth transistor, a second resistor, and a first optocoupler, the first power source electrically connected to a hard disk power interface of the hard disk via a collector electrode and an emitter electrode of the third transistor, the first power source is also electrically connected to an emitter electrode of the fourth transistor, a base electrode of the fourth transistor is electrically connected to the hard disk power interface via the second resistor and the first optocoupler, an anode of a diode of the first optocoupler is electrically connected to one control terminal group of two adjacent two control terminal groups, a cathode of the diode of the first optocoupler is electrically connected to one control terminal group of two adjacent two control terminal groups.

11. The control circuit of claim 10, wherein when the input and output pin outputs a current to the diode of the first optocoupler, the third transistor and the fourth transistor are turned on, the first power source supplies power for the hard disk.

12. The control circuit of claim 9, wherein each data control unit comprises four dry-reed relays, each dry-reed relay comprises a switch and an inductor, each switch corresponds to one data wire of a data interface of the hard disk, one end of each inductor is electrically connected to an emitter electrode of a fifth transistor, the other end of each inductor is electrically connected to an emitter electrode of a sixth transistor, a base electrode of the fifth transistor is electrically connected to the other control terminal group of the two adjacent control terminal groups, and a base electrode of the sixth transistor is electrically connected to the other control terminal group of the two adjacent control terminal groups.

13. The control circuit of claim 12, when the input and output pin outputs a current to the four dry-reed relays, the switches of the four dry-reed relays are turned on to cut off data transmission of hard disk.

14. The control circuit of claim 1, further comprising a connector is connected between the controller and a host, the host configured to turn on or off the hard disk.
